(19) United States
(12) Patent Application Publication
(10) Pub. No.: US 2006/0059246 A1
(43) Pub. Date: Mar. 16, 2006

(54) System and method for connection optimization

(76) Inventor: Adam J. Grove, Mountain View, CA (US)

Correspondence Address: WHITE & CASE LLP;PATENT DEPARTMENT, 1155 AVENUE OF THE AMERICAS, NEW YORK, NY, 10036, US

(21) Appl. No.: 10/937,929

(22) Filed: Sep. 10, 2004

(51) Int. Cl. G06F 15/16

(52) U.S. Cl. 709/219

(57) ABSTRACT

A system for connection optimization includes a client, a server, and a domain assigner configured to assign referenced objects to additional domains to influence the number of connections used by the client for requesting and receiving the referenced objects. In one embodiment, the domain assigner dynamically assigns referenced objects to additional domains based on conditions in the network. In another embodiment, the domain assigner stores a plurality of versions of a referencing object wherein the referenced objects of each version are assigned to different numbers of domains. The domain assigner may be implemented at the server or at an intermediate device.

### FIELD OF THE INVENTION

This invention relates generally to computer networks and relates more particularly to a system and method for connection optimization in a client-server network.

### BACKGROUND

In some circumstances, the usefulness of the World Wide Web is limited because of poor performance. A web client, for example a web browser, may find that an individual web page or other object takes many seconds to retrieve. Although this may be acceptable in some situations (e.g., a person on-line shopping at home), in some business applications where client productivity is important such a delay in retrieving an object lowers efficiency.

A web client communicates with a web server using a layered suite of protocols that generally includes the Internet Protocol (IP), which is a connectionless low level protocol for single packet delivery. The suite of protocols also generally includes a transport layer protocol, such as Transmission Control Protocol (TCP), that uses IP to create transport connections. A transport connection appears to the client and the server as a way of sending a stream of data, where the transport protocol provides reliability and sequencing. Transport connections are opened by one side, typically the client. Establishing connections is somewhat costly in both time and bandwidth. Maintaining connections involves costs as well, for example memory usage, so connections are typically closed after they have served their purpose or after some delay.

The HyperText Transfer Protocol (HTTP) is the standard protocol for retrieving web objects. HTTP provides a way for a client to request an object, identified by a Uniform Resource Locator (URL), and a server to provide a response that typically includes the requested object. A URL includes a domain name and a path. The domain name identifies the server (or group of servers) where the object resides. The path typically identifies a particular web object that resides on the server. A web page is generally a structured collection of multiple objects. A HyperText Markup Language (HTML) object may reference other objects, for example images, frames, and code objects. A web browser at the client can download such referenced or embedded objects and compose them on a single screen that is presented to a user. The need to download multiple objects to produce a single page is one cause of poor web performance.

The number of domains related to a particular web page can influence the number of concurrently used connections, i.e., the level of parallelism, between the client and the server. An increase in parallelism can somewhat improve latency but typically also increases load on the client, the server, and the network.

### SUMMARY

A system for connection optimization includes a client, a server, and a domain assigner configured to assign referenced objects to additional domains to influence the client to open additional connections. The client opens a transport connection to the server to request a referencing object that includes a plurality of referenced objects. In one embodiment, the domain assigner is configured to dynamically assign the plurality of referenced objects to additional domains when the referencing object is requested. The web browser software at the client sees that the referenced objects are assigned to the additional domains and opens additional transport connections to request the referenced objects. The domain assigner may assign the plurality of referenced objects to additional domains based on conditions in the network, such as load and available bandwidth. In another embodiment, the domain assigner is configured to create multiple versions of a referencing object wherein the referenced objects of each version are assigned to different numbers of domains. The domain assigner may reside at the server or at an intermediate device in the network. The additional connections may be made to the server that delivered the referencing object, if that server is capable of delivering the referenced objects, or may be made to one or more other servers capable of delivering the referenced objects.

A method for connection optimization includes establishing a connection between a server and a client, receiving a request for an object that includes referenced objects, determining a desired number of connections between the server and the client, determining a domain assignment for each of the plurality of referenced objects to influence the client to use the desired number of connections, assigning each of the plurality of referenced objects to one of a plurality of domains according to the domain assignment, modifying the object to include identifiers for the plurality of referenced objects in accordance with the domain assignment of each of the plurality of referenced objects to produce a modified object, and sending the modified object to the client. In one embodiment, the step of determining a domain assignment includes determining a number of domains based on network conditions such as load and available bandwidth.

### BRIEF DESCRIPTION OF THE DRAWINGS

FIG. 1 is a block diagram of one embodiment of a computer network, in accordance with the present invention;

FIG. 2 is a block diagram of one embodiment of an object including referenced objects; in accordance with the invention; and

FIG. 3 is a block diagram of another embodiment of a computer network, in accordance with the invention.

### DETAILED DESCRIPTION

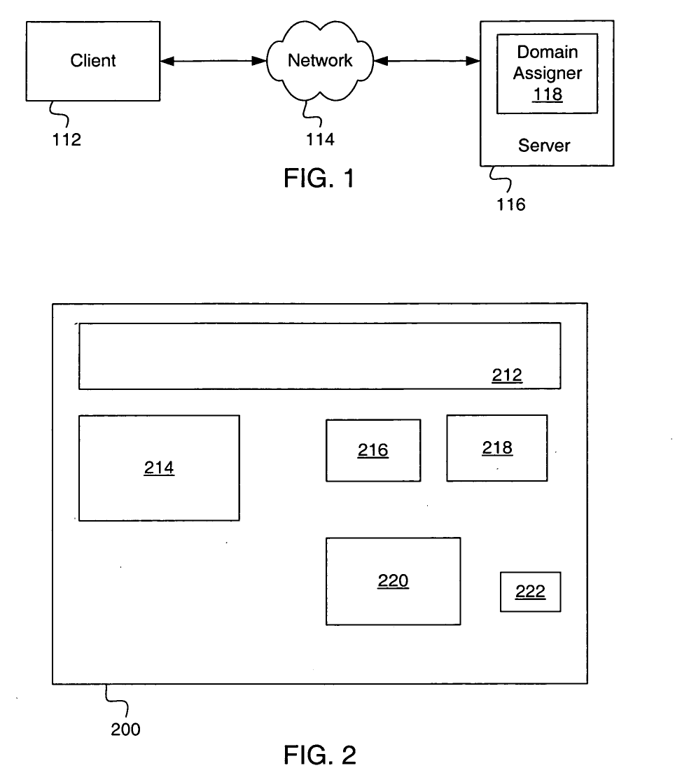

FIG. 1 is a block diagram of one embodiment of a computer network, in accordance with the invention. The network includes, but is not limited to, a client 112, a network 114, and a server 116. Client 112 requests and receives objects from server 116 via network 114 using software such as a web browser. The objects may include HTML objects, such as web pages. To request an object, client 112 opens a transport layer connection, for example a TCP connection, with server 116. Client 112 then sends a request for the object to server 116 over the connection.

Some objects stored at server 116 reference other objects. A referencing object includes identifiers, such as Uniform Resource Locators (URLs), of the referenced objects. An identifier of a referenced object includes a domain where the referenced object is located. When a referencing object is received by client 112, the browser software at client 112 then requests the referenced objects according to the identifiers. Each of the referenced objects is capable of being assigned to more than one domain.

Server 116 includes, but is not limited to, a domain assigner 118. Domain assigner 118 is configured to assign referenced objects to a domain. When a referenced object is created, it is assigned to an initial domain that is usually the domain of the referencing object. In the FIG. 1 embodiment, domain assigner 118 dynamically assigns referenced objects to a plurality of domains and modifies the identifiers in the referencing object when the referencing object is requested by client 112, producing a modified referencing object. Server 116 then sends the modified referencing object to client 112. Domain assigner 118 assigns referenced objects to the plurality of domains to influence the number of connections, or level of parallelism, between client 112 and server 118.

For example, a referencing object may be identified by a URL “www.site.com/index.html,” and reference twenty referenced objects. The referenced objects may be initially identified by the URLs “www.site.com/imageN.gif” for N=1-20, which belong to the same domain as the referencing object. When client 112 requests the referencing object, domain assigner 118 dynamically assigns the referenced objects to different domains to cause client 112 to open additional connections with server 116. In this example, domain assigner 118 assigns one half of the referenced objects to one new domain, “www2.site.com/imageN.gif” for N=1, 3, 5, 7, . . . 19, prior to server 116 sending the referencing object to client 112. Client 112 will recognize that www2.site.com is a different domain, and will then open additional transport connections to request the referenced objects from the different domain. Since most web browsers are configured to use two connections per domain, client 112 will use four connections to receive the requested referenced objects from server 116.

Domain assigner 118 may assign referenced objects to a predetermined number of domains or may dynamically determine an appropriate number of domains based on the number of desired connections, or level of parallelism, with client 112. In the preferred embodiment, domain assigner 118 determines an appropriate level of parallelism based on load, priority, or other factors, and then determines a number of domains to achieve that level of parallelism. In one embodiment, domain assigner 118 determines the appropriate number of domains based on historical data captured by server 116 as to how many connections per domain client 112 actually does open. In another embodiment, domain assigner 118 determines the appropriate number of domains based on a prediction of client behavior according to the browser type used by client 112, which the browser used by client 112 makes known in its request. Domain assigner 118 may also determine a desired number of connections with client 112 based on the bandwidth or latency of connections with client 112, the computing power of client 112, the type and version of the browser software of client 112, or an estimate of any of these factors.

Domain assigner 118 may also cause client 112 to open a desired number of connections with server 116 by instructing server 116 to respond to a request from client 112 with a specified version of the HTTP protocol. For example, some clients open more connections with a server when using version 1.0 of the HTTP protocol. Thus domain assigner 118 can influence the level of parallelism used by client 112 by instructing server 116 to respond to a request from client 112 using either version 1.0 or version 1.1 of the HTTP protocol.

In another embodiment, domain assigner 118 creates multiple versions of a referencing object, where the referenced objects of each version are assigned to different numbers of domains. Domain assigner 118 creates these multiple versions prior to receiving a request from client 112. When client 112 requests the referencing object from server 116, domain assigner 118 selects the version of the referencing object having the number of domains for the referenced objects that will cause client 112 to open the desired number of connections. The number of connections desired between client 112 and server 116 may be a predetermined number or domain assigner 118 may determine the number of desired connections based on the load at server 116. Other methodologies for determining a number of desired connections between client 112 and server 116 are within the scope of the invention.

In one embodiment, domain assigner 118 determines which of the referenced objects to assign to different domains based on different factors, such as the importance assigned to the referenced objects or where the referenced objects occur on a web page.

Assigning referenced objects to different domains does not usually require additional servers. For example, the virtual hosting facility of HTTP allows a single server to be configured to treat multiple domains as aliases for each other. If all of the domains for the referenced objects are subdomains of a single parent domain, then the wildcard configuration option of the Domain Name Service (DNS) may be used to simplify DNS setup. Other techniques for applying multiple domains to a single server known in the art are within the scope of the invention.

In the FIG. 1 embodiment, server 116 is capable of delivering all of the referenced objects to client 112. In other embodiments, one or more other servers in network 114 may be capable of delivering all of the referenced objects to client 112, and thus client 112 may open the additional connections with servers other than server 116 to request the referenced objects.

FIG. 2 is a block diagram of one embodiment of an object 200 including referenced objects, in accordance with the invention. Object 200 includes, but is not limited to, referenced objects 212, 214, 216, 218, 220, and 222. Each of referenced objects 212-222 may be a text object, an image object, an audio object, a video object, an animation object, a code object (e.g., Java applet), or any other type of object. When client 112 receives object 200 from server 116, client 112 then requests each of referenced objects 212-222.

In the FIG. 2 embodiment, referenced objects 212 and 214 are assigned to the domain of object 200, referenced objects 216 and 218 are assigned to a second domain, and referenced objects 220 and 222 are assigned to a third domain. When client 112 receives object 200 from server 116, client 112 recognizes that the identifiers for referenced objects 216-222 point to the second and third domains. Client 112 opens at least one transport layer connection with a server capable of servicing the second and third domains to request referenced objects 216-222, for instance server 116. Since more than one referenced object is assigned to each of the different domains, client 112 may open more than one transport layer connection for each of the different domains. Thus, for requesting and receiving referenced objects 212-222, client 112 may use six parallel connections (two per domain) with server 116. By using six transport connections instead of two, client 112 receives referenced objects 212-222 and presents object 200 with its referenced objects to a user with less latency. In general, when a client wishes to open a transport layer connection to a domain, the client will use a look-up system such as DNS to discover one or more servers capable of servicing that domain and will open a transport connection to one of these servers.

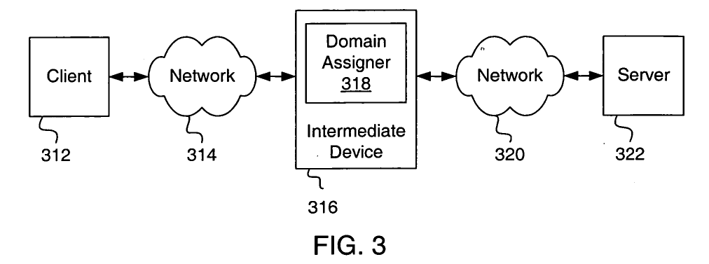

FIG. 3 is a block diagram of another embodiment of a computer network, in accordance with the invention. The network of FIG. 3 includes, but is not limited to, a client 312, a network 314, an intermediate device 316, a network 320, and a server 322. Intermediate device 316 may be any type of intermediate network device, for example a load balancer or web proxy. In one embodiment, intermediate device 316 may be embodied as a dedicated performance enhancing device. Examples of such specialized nodes are disclosed in U.S. patent application Ser. No. 09/534,321, entitled “Method for High-Performance Delivery of Web Content,” filed Mar. 24, 2000, which is hereby incorporated by reference in its entirety.

Intermediate device 316 includes, but is not limited to, a domain assigner 318. Domain assigner 318 is configured to receive a referencing object from server 322 and dynamically assign its referenced objects to at least one additional domain that is different than the domain of the referencing object as seen by client 312 to influence the number of connections used by client 312. Intermediate device 316 sends the resulting modified referencing object to client 312. When requesting the referenced objects, client 312 opens at least one additional connection with intermediate device 316.

In one embodiment, intermediate device 316 includes a cache that stores content received from server 322. Domain assigner 318 can dynamically assign referenced objects of cached referencing objects to additional domains. Alternatively, domain assigner 318 can create different versions of a cached referencing object, where the referenced objects of each version are assigned to different numbers of domains. For example, one version of a cached referencing object may include ten referenced objects where half of the referenced objects are assigned to one domain and half are assigned to another domain. In another version of the cached referencing object, the ten referenced objects may be assigned among three different domains. Domain assigner 318 determines which version of the cached referencing object to send to client 312 depending on the number of connections desired between client 312 and intermediate device 316. The number of connections desired between client 312 and intermediate device may be a predetermined number or domain assigner 318 may determine the number of desired connections based on the load at intermediate device 316. Other methodologies for determining a number of desired connections between client 312 and intermediate device 316 are within the scope of the invention.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method for optimizing connections, comprising:
establishing an initial connection between a server and a client;
receiving a request for an object at the server, the object referencing a plurality of referenced objects, wherein at least one of the plurality of referenced objects is capable of being assigned to one or more domains;
assigning the plurality of referenced objects to a plurality of domains to influence a number of connections used by the client to request the plurality of referenced objects;
modifying the object to include identifiers for the plurality of referenced objects assigned to the plurality of domains, producing a modified object; and
sending the modified object to the client.

2. The method of claim 1, wherein the step of assigning the plurality of referenced objects to a plurality of domains includes assigning the plurality of referenced objects to a number of domains depending on the load at the server.

3. The method of claim 1, wherein the step of assigning the plurality of referenced objects to a plurality of domains includes assigning the plurality of referenced objects to a number of domains depending on available bandwidth in a network between the client and the server.

4. The method of claim 1, wherein the step of assigning the plurality of referenced objects to a plurality of domains includes assigning the plurality of referenced objects to a number of domains depending on available bandwidth at the client.

5. The method of claim 1, wherein the step of assigning the plurality of referenced objects to a plurality of domains includes assigning the plurality of referenced objects to a number of domains depending on a priority of the client.

6. The method of claim 1, wherein the step of assigning the plurality of referenced objects to a plurality of domains includes assigning the plurality of referenced objects to a predetermined number of domains.

7. The method of claim 6, wherein the predetermined number of domains is selected to improve download performance under typical conditions.

8. The method of claim 1, wherein at least two of the plurality of domains are capable of being serviced by a single server for at least two of the plurality of referenced objects.

9. The method of claim 8, wherein the single server uses an HTTP virtual host facility to service multiple domains.

10. The method of claim 8, wherein the single server is identical to the server storing the object.

11. A method for optimizing connections, comprising:
establishing an initial connection between a server and a client;
receiving a request for an object at the server, the object referencing a plurality of referenced objects, wherein at least one of the plurality of referenced objects is capable of being assigned to one or more domains;
determining a desired number of connections for the client to use in requesting and receiving the plurality of referenced objects;
determining a domain assignment for each of the plurality of referenced objects to influence the client to use the desired number of connections;
assigning each of the plurality of referenced objects to one of a plurality of domains according to the domain assignment;
modifying the object to include identifiers for the plurality of referenced objects in accordance with the domain assignment of each of the plurality of referenced objects, producing a modified object; and
sending the modified object to the client.

12. The method of claim 11, wherein the step of determining a domain assignment for each of the plurality of referenced objects includes determining a number of domains depending on a load at the server.

13. The method of claim 11, wherein the step of determining a domain assignment for each of the plurality of referenced objects includes determining a number of domains depending on available bandwidth in a network between the client and the server.

14. The method of claim 11, wherein the step of determining a domain assignment for each of the plurality of referenced objects includes determining a number of domains depending on available bandwidth at the client.

15. The method of claim 11, wherein the step of determining a domain assignment for each of the plurality of referenced objects includes determining a number of domains depending on available bandwidth at the server.

16. The method of claim 11, wherein the step of determining a domain assignment for each of the plurality of referenced objects includes determining a number of domains depending on a priority of the client.

17. The method of claim 11, wherein the domain assignment is predetermined.

18. The method of claim 11, wherein the domain assignment is predetermined to improve download performance under typical conditions.

19. A system for optimizing connections, comprising:
a server storing an object, the object referencing a plurality of referenced objects, wherein at least one of the plurality of referenced objects is capable of being assigned to one or more domains; and
a domain assigner configured to determine a desired number of connections for a client to use in requesting and receiving the plurality of referenced objects and to assign each of the plurality of referenced objects to one of a plurality of domains to influence the client to establish the desired number of connections.

20. The system of claim 19, wherein the domain assigner is configured to assign each of the plurality of referenced objects to one of the plurality of domains depending on a load at the server.

21. The system of claim 19, wherein the domain assigner is configured to assign each of the plurality of referenced objects to one of the plurality of domains depending on available bandwidth in a network between the client and the server.

22. The system of claim 19, wherein the domain assigner is configured to assign each of the plurality of referenced objects to one of the plurality of domains depending on available bandwidth at the client.

23. The system of claim 19, wherein the domain assigner is configured to assign each of the plurality of referenced objects to one of the plurality of domains depending on available bandwidth at the server.

24. The system of claim 19, wherein the domain assigner is configured to assign each of the plurality of referenced objects to one of the plurality of domains depending on a priority of the client.

25. The system of claim 19, wherein the domain assigner is configured to assign each of the plurality of referenced objects to one of the plurality of domains according to a predetermined domain assignment.

26. The system of claim 25, wherein the predetermined domain assignment is selected to improve download performance under typical conditions.

27. The system of claim 19, wherein the domain assigner resides at the server.

28. The system of claim 19, wherein the domain assigner resides at an intermediate device between the client and the server.

29. The system of claim 28, wherein the domain assigner is configured to determine a desired number of connections between the client and the intermediate device based on a load at the intermediate device.

30. The system of claim 28, wherein the domain assigner is configured to determine a desired number of connections between the client and the intermediate device based on available bandwidth at the intermediate device.

31. The system of claim 28, wherein the domain assigner is configured to determine a desired number of connections between the client and the intermediate device based on available bandwidth in a network between the client and the intermediate device.

32. The system of claim 28, wherein the domain assigner is further configured to instruct the intermediate device to respond to a request from the client using HTTP version 1.0 to influence the client to increase the number of connection between the client and the intermediate device.

33. The system of claim 19, wherein the domain assigner is further configured to instruct the server to respond to a request from the client using HTTP version 1.0 to influence the client to increase the number of connections between the client and the server.

34. A system for optimizing connections, comprising:
a server storing an object, the object referencing a plurality of referenced objects; and
a domain assigner configured to determine a desired number of connections for a client to use in requesting and receiving the plurality of referenced objects, and further configured to select one of a plurality of versions of the object to influence the client to establish the desired number of connections, wherein each of the plurality of versions of the object includes a unique number of domains to which the plurality of referenced objects is assigned.

35. The system of claim 34, wherein the domain assigner is configured to select one of the plurality of versions of the object depending on a load at the server.

36. The system of claim 34, wherein the domain assigner is configured to select one of the plurality of versions of the object depending on available bandwidth in a network between the client and the server.

37. The system of claim 34, wherein the domain assigner is configured to select one of the plurality of versions of the object depending on available bandwidth at the client.

38. The system of claim 34, wherein the domain assigner is configured to select one of the plurality of versions of the object depending on available bandwidth at the server.

39. The system of claim 34, wherein the domain assigner is configured to select one of the plurality of versions of the object depending on a priority of the client.
